(19) United States
(12) Patent Application Publication
(10) Pub. No.: US 2026/0356278 A1
(43) Pub. Date: Nov. 12, 2026

(54) VEHICLE DRIVING LIGHT WITH INTERNAL VOLTAGE SENSOR RECEIVING HI-BEAM SIGNAL

(71) Applicant: BROWN & WATSON INTERNATIONAL PTY LTD, Knoxfield, Victoria (AU)

(72) Inventor: Joshua GRABOVIC, Melbourne, Victoria (AU)

(21) Appl. No.: 19/120,860

(22) PCT Filed: Oct. 6, 2023
(86) PCT No.: PCT/AU2023/050972

§ 371 Date: Apr. 14, 2025

(30) Foreign Application Priority Data
Oct. 13, 2022 (AU) 2022903005

(51) Int. Cl. B60Q 1/00; H05B 45/14; H05B 47/19

(52) U.S. Cl. CPC B60Q 1/0088; H05B 45/14; H05B 47/19

(57) ABSTRACT

A vehicle lighting control apparatus includes a sensing wire and a lighting control module. The sensing wire is adapted to sense a voltage of a corresponding wiring loom. The lighting control module is operably connected to the sensing wire. The lighting control module is adapted to detect at least a threshold voltage and/or voltage change in the corresponding wiring loom through the sensing wire, and in response, generate a control signal to control a corresponding lighting circuit.

### CROSS-REFERENCE TO RELATED APPLICATIONS

This application is a national stage application, filed under 35 U.S.C. § 371, of International Patent Application No. PCT/AU2023/050972, filed Oct. 6, 2023, which claims priority to AU2022903005, filed Oct. 13, 2022. Each of these priority applications is incorporated by reference herein in its entirety.

### FIELD

The present application relates to vehicle lighting circuits and in particular to lighting circuits designed for retrofitting into vehicles.

Embodiments of the present invention are particularly adapted for driving lights for automobile applications. However, it will be appreciated that the invention is applicable in broader contexts and other applications.

### BACKGROUND

Currently the aftermarket installation of driving lights typically requires the skills of an auto electrician as these installations often require partial rewiring of the vehicles lighting circuitry, including the installation of components such as relays and the like. Thus, the installation of aftermarket automobile lighting requires specialised skills posing difficulties for the average user.

An example of a current aftermarket installation is shown in FIG. 1, where the significant rewiring of a vehicles wiring is exemplified. In FIG. 1 we see that there is a necessity for the installation of additional wiring and relays which typically require specialized auto electrical knowledge to install correctly. Additionally, the significant rewiring required is time consuming significantly adding to the total cost of an install. As can be seen in FIG. 1, which exemplifies current aftermarket lighting installations, typically a relay 100 for switching the moderately high currents that may be present in lighting circuits. Relays 100 typically require some specialised knowledge to install correctly such that they function as intended. As can be seen in FIG. 1, the relay 100 may have multiple wire connections, which in this case is five, each needs to be wired to the correct terminal on the relay 100 in order for the relay to function as designed. Additionally, a control module 102 is typically required to control the operation of the relay 100 and thus the operation of the lights 106 via the relay 100. As is exemplified in FIG. 1, a significant amount of wiring is required when installing after market lighting systems on vehicles using present techniques.

Therefore, it is desirable to have a means of installing additional aftermarket automobile lights which requires minimum skills and minimises the electrical rewiring required.

Any discussion of the background art throughout the specification should in no way be considered as an admission that such art is widely known or forms part of common general knowledge in the field.

### SUMMARY

In accordance with an aspect of the present invention, there is provided a vehicle lighting control apparatus, comprising:
a sensing wire, adapted to sense a voltage of a corresponding wiring loom;
a lighting control module, operably connected to the sensing wire; and
wherein, the lighting control module is adapted to detect at least a threshold voltage and/or voltage change in the corresponding wiring loom through the sensing wire, and in response, generate a control signal to control a corresponding lighting circuit.

In one embodiment, the lighting control module is programmable.

In one embodiment, the lighting control module is programmable to sense signal changes in the corresponding wiring loom and in response, generate a unique output control signal.

In one embodiment, the lighting control module is programmable to ramp up the output control signal based on a predefined voltage change of the sensed voltage in the corresponding wiring loom.

In one embodiment, the lighting control module is programmable to turn on or off based on a predefined sensed voltage pattern detected through the sensing wire.

In one embodiment, the lighting control module is additionally controllable via a serial network protocol.

In one embodiment, the serial network protocol is Local Interconnect Network (LIN).

In one embodiment, the lighting control module is adaptably connected to a user operable control module.

In one embodiment, the user operable control module is controllable via a wireless protocol.

In one embodiment, the wireless protocol is a Bluetooth protocol.

### BRIEF DESCRIPTION OF THE FIGURES

Example embodiments of the disclosure will now be described, by way of example only, with reference to the accompanying drawings in which:

FIG. 1 is a schematic diagram of a prior art system;

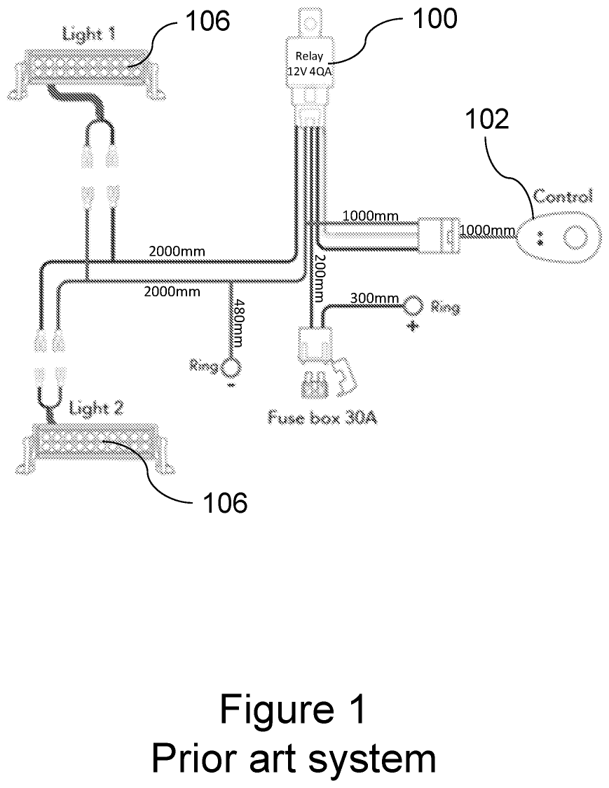

FIG. 2 shows an embodiment of a vehicle lighting control apparatus;

FIG. 3 shows a further embodiment of the vehicle lighting apparatus;

FIG. 4 shows a layout of an embodiment of the vehicle lighting apparatus located within a wiring loom;

FIG. 5 shows a physical schematic layout of the lighting control apparatus of FIG. 2 being controllable using a serial network protocol; and

FIG. 6 shows a 4 pin DEUTSCH as used in an embodiment.

### DESCRIPTION OF THE INVENTION

It should be noted in the following description that like or the same reference numerals in different embodiments denote the same or similar features.

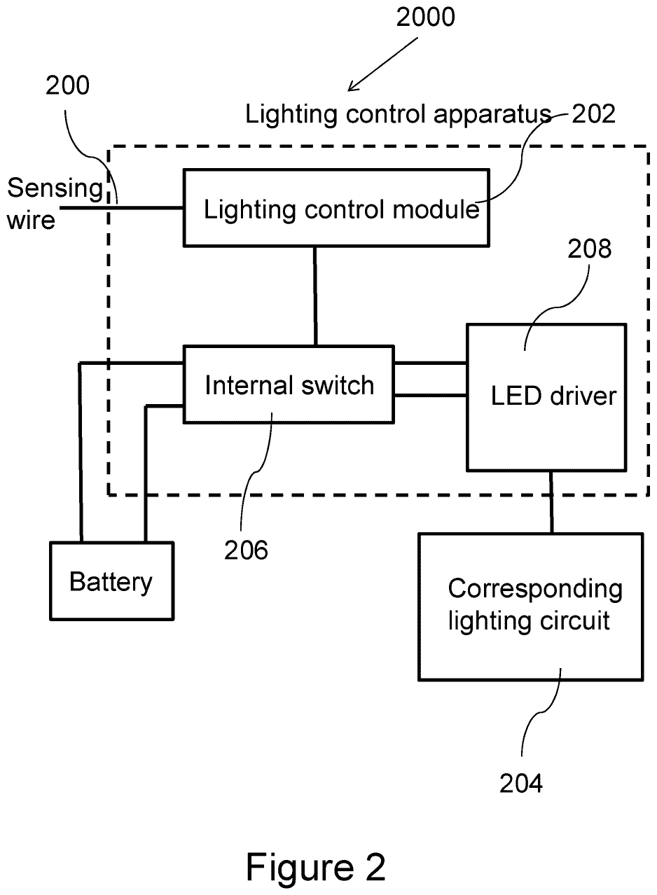

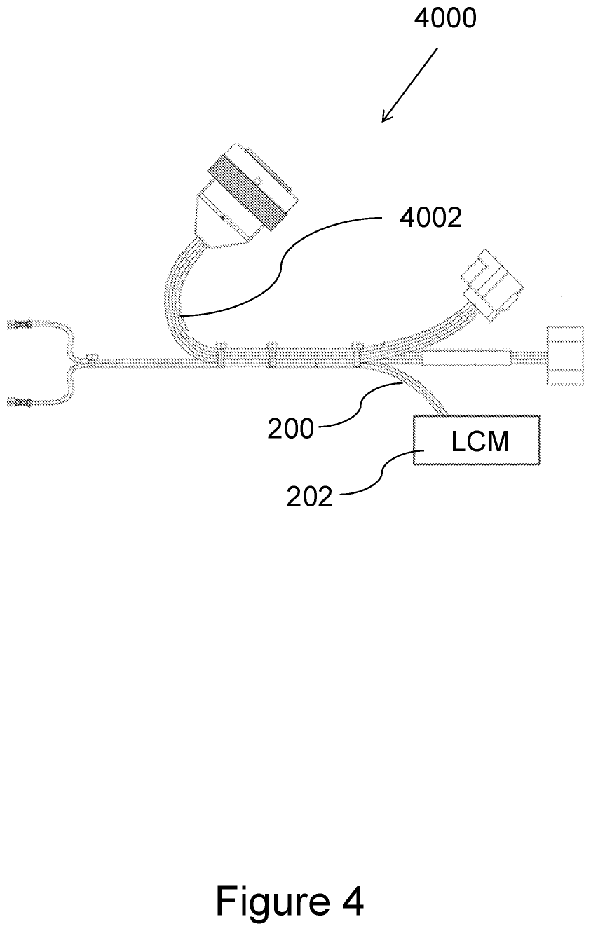

FIG. 2 shows a vehicle lighting control apparatus 2000 in accordance with an embodiment of the invention. The lighting control apparatus 2000 includes a sensing wire 200 which is adapted to sense a voltage in a corresponding wiring loom 4002 of a vehicle (as exemplified in FIG. 4). In the embodiment shown in FIG. 4, the wiring loom 4002 is associated with the lighting system of a vehicle.

Returning to FIG. 2, the vehicle lighting control apparatus 2000 includes a lighting control module 202 which is adapted to sense a threshold voltage or voltage change within the corresponding wiring loom 4002 (exemplified in FIG. 4) via the sensing wire 200 and generate a control signal to control a corresponding lighting circuit 204. As can be seen in FIG. 4, in the embodiment shown the lighting control module 202 may have its output fed into an internal switch 206 which is operably connected to an LED driver circuit 208 which provides a suitable output to power the corresponding lighting circuit 204.

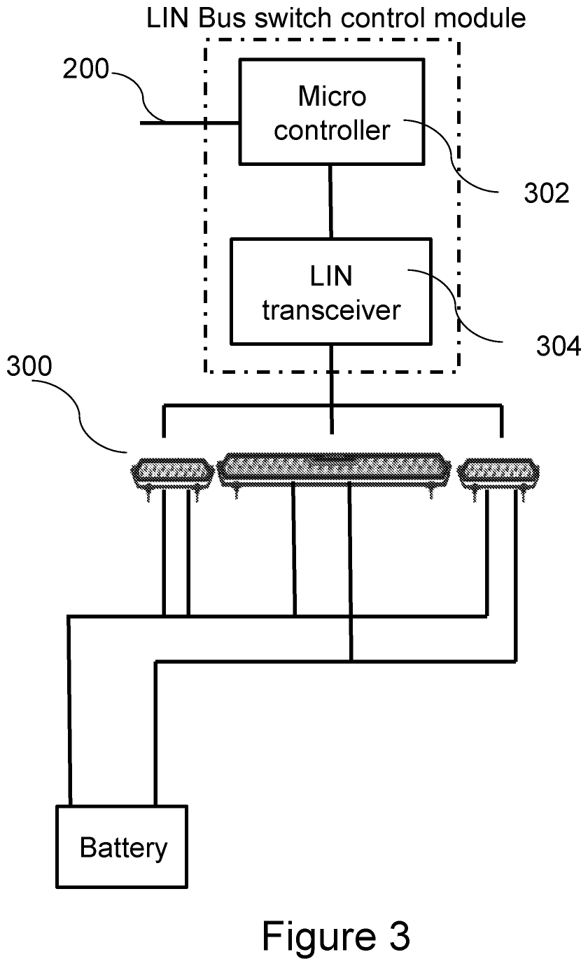

Referring to FIG. 3, a further embodiment is shown employing a means for controlling the lighting control module via a serial network protocol, which in the embodiment shown is a Local Interconnect Network (LIN) protocol. In the embodiment shown in FIG. 3, a sensing wire 200 is operably connected to a microcontroller 302 which is configured to output a control signal to a LIN transceiver 304. LIN is a serial network protocol that is commonly used in vehicle control systems. It will be appreciated by a person skilled in the art that other serial protocols may be used with similar utility, with the LIN protocol being used due to its lower cost as compared to similar protocols such as CAN Bus. In the embodiment shown, an array of driving lights 300 are adapted to communicate via the LIN protocol with the LIN transceiver which is adapted to send commands to the driving lights 300. The driving lights 300 then respond to the commands sent from the LIN transceiver 304 which in turn control the driving lights 300.

As can be seen in FIG. 4, the sensing wire 200 may be attached to the main wiring loom 4002 using a variety of different methods including cable ties, heat shrink or electrical tape to name a few examples. Ideally, the sensing wire 200 should be securely fixed to the wiring loom 4002 in order to allow for the sensing wire 200 to be integrated into the wiring loom 4002. Typically, the sensing wire 200 is adapted to sense voltages and/or voltage changes on the wiring looms associated with the vehicles electrical lighting system, such as the wiring associated with the high beam lights. In this regard, the sensing wire 200 may be tapped into the high beam circuit to sense when the high beam circuit is active. This may result in the activation of driving lights depending on the configuration of the lighting control module 202.

In one embodiment, the lighting control module 202 provides an output in response to the signal received on the sensing wire 200, the output may consist of an on/off control voltage depending on the sensed voltage from the sensing wire 200. In other embodiments, the lighting control module 202 is programmable. In the case where the lighting control module 202 is programmable, the lighting control module 202 takes as an input, the signal from the sensing wire 200 and generates an output based on the sensed signal from the sensing wire 200.

As an example, when the operator of the vehicle switches the high beam lights on through the vehicles wiring loom 4002, the sensing wire 200 will sense the current in the high beam circuit and may take certain actions depending on the output from the sensing wire 200. For instance, if the operator of the vehicle flashes the high beam light, this signal may be detected and sent to the lighting control module 202, which may be programmed to trigger specific functions dependent on the sensed signal. For example, if a signal representing flashing of the high beam lights is detected, the lighting control module 202 may be programmed to perform a ramping function where the output circuit to the driving light might gradually increase in current from 0% to 100% over a predetermined time interval which can be programmed into the lighting control module 202. The result would be that the operator of the vehicle avoids flashing oncoming vehicles with their high beam lights. Other examples of functions that may be programmed into the lighting control module 202, may include detecting pre-programmed detected sequences for turning the lamp on or off. For example, if an operator activates the high beam circuit three times within say a two second period, the lighting control module 202 may be programmed to turn off the driving lights as one example. As will be appreciated by a skilled person, that many other functions may be programmed into the lighting control module 202 in this way. This programmability allows for functionality to be readily integrated into the lighting control module 202 based on the signals sensed by the sensing wire 200. Furthermore, as the only modification that is required to the vehicle's existing wiring loom is the integration of the sensing wire, this results in minimal tampering with the existing wiring circuit. This may also be of benefit, if the lighting control apparatus 2000 is to be uninstalled as this will merely require the removal of the sensing wire from the wiring loom in many cases. This is in contrast with current systems where significant rewiring may be required upon removal of the aftermarket lighting system to return the wiring loom to its original state after removal.

The programmability of the lighting control module 202 may be achieved using an EPROM, EEPROM, FPGA or similar chip with the possibility of upgrading the functionality by reprogramming the chip with new firmware through a programming port (not shown). The chip may be programmed to detect a variety of commonly generated signals, providing a unique output control signal for powering the driving lights 300 based on the signal sensed by the sensing wire 200. Other functions such as turning on or off the driving lights 300 may be programmed depending on specific signals detected by the sensing wire 200.

In other embodiments, the lighting control module is adaptively connected to a user operable control module (not shown) to facilitate control from within the vehicle.

In other embodiments, the user operable control module is controllable via a wireless protocol such as Bluetooth.

In one embodiment, the lighting control module 202 is programmable to ramp up the output control signal based on a predefined voltage change of the sensed voltage in the corresponding wiring loom. Alternatively, the lighting control module 202 may be programmable to turn on or off based on a predefined sensed voltage pattern detected through the sensing wire 200.

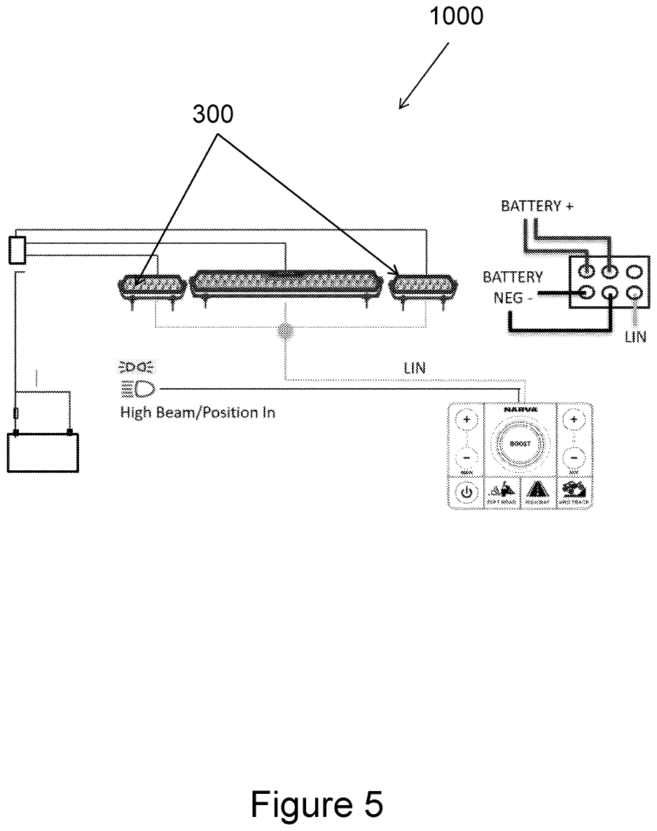

Referring to FIG. 5, an example of an installation of an embodiment of the invention is shown. In this embodiment, the lighting control module 202 is located within the driving lights 300. It will be appreciated by a person skilled in the art, that the means of lighting may take a number of forms such as halogen lights or as is exemplified in FIGS. 3 and 5, an LED lighting matrix.

FIG. 5 exemplifies an implementation of an embodiment of the invention in where the lighting control module 202 is additionally controllable via a serial network protocol. In the embodiment shown, the serial network protocol is a Local Interconnect Network (LIN). The serial network control provides for the ability to customise lighting patterns by the ability to remotely control the lighting control module 202 from the interior cabin of the vehicle.

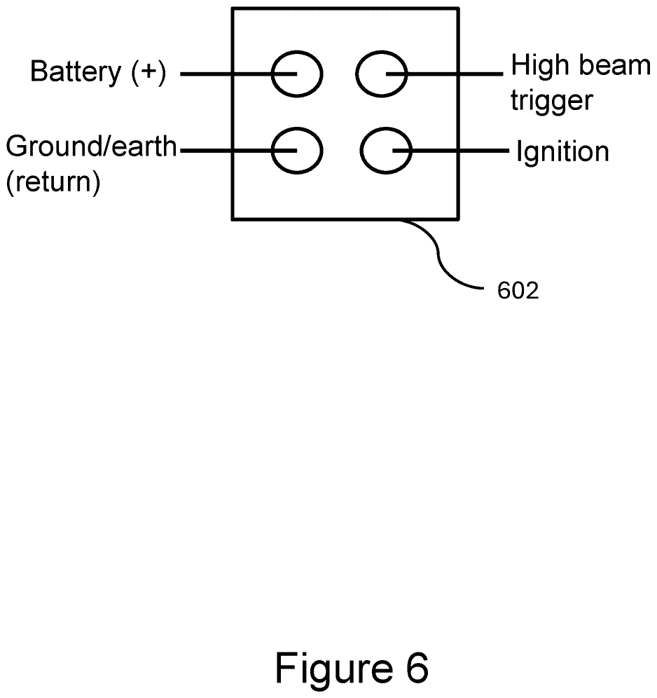

Referring to FIG. 6, in order to interface with the vehicles lighting wiring loom 4002, a 4 pin DEUTSCH (DT) connector 302 may be used as one of a number of examples. The 4 pin DT connector 302 includes a battery pin, high beam trigger pin, chassis earth and ignition on pin. The use of the DT connector 302 facilitates installation of the lighting control apparatus 2000 without the necessity of splicing into the existing wiring loom 4002, thus avoiding potential damage to the existing wiring loom 4002. By interfacing in this way, there is no requirement for an additional external relay and the lighting control apparatus 2000 can be directly connected to the battery for power and the high beam wiring via the sensing wire 200 with minimal interference with the existing wiring loom 4002.

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1. A vehicle lighting control apparatus, comprising:
a sensing wire, adapted to sense a voltage of a corresponding wiring loom;
a lighting control module, operably connected to the sensing wire; and
wherein, the lighting control module is adapted to detect at least one of a threshold voltage or a voltage change in the corresponding wiring loom through the sensing wire, and in response, generate a control signal to control a corresponding lighting circuit.

2. The vehicle lighting control apparatus of claim 1, wherein the lighting control module is adapted to adjust brightness of the corresponding lighting circuit.

3. The vehicle lighting control apparatus of claim 1, wherein the lighting control module is programmable.

4. The vehicle lighting control apparatus of claim 3, wherein the lighting control module is programmable to sense signal changes in the corresponding wiring loom and in response, generate the control signal as a unique output control signal.

5. The vehicle lighting control apparatus of claim 3, wherein the lighting control module is programmable to ramp up the control signal based on a predefined voltage change of the voltage that is sensed in the corresponding wiring loom.

6. The vehicle lighting control apparatus of claim 3, wherein the lighting control module is programmable to turn on or off based on a predefined sensed voltage pattern detected through the sensing wire.

7. The vehicle lighting control apparatus of claim 1, wherein the lighting control module is additionally controllable via a serial network protocol.

8. The vehicle lighting control apparatus of claim 7, wherein the serial network protocol is Local Interconnect Network (LIN).

9. The vehicle lighting control apparatus of claim 7, wherein the lighting control module is adaptably connected to a user operable control module.

10. The vehicle lighting control apparatus of claim 9, wherein the user operable control module is controllable via a wireless protocol.

11. The vehicle lighting control apparatus of claim 10, wherein the wireless protocol is a BLUETOOTH protocol.
